(19) United States
(12) Patent Application Publication
(10) Pub. No.: US 2008/0000081 A1
(43) Pub. Date: Jan. 3, 2008

(54) Method for the production of a pressure-bearing part

(76) Inventor: Britta Daume, Hannover (DE)

Correspondence Address: SHLESINGER, ARKWRIGHT & GARVEY LLP, 1420 KING STREET, SUITE 600, ALEXANDRIA, VA, 22314, US

(21) Appl. No.: 11/806,072

(22) Filed: May 29, 2007

Related U.S. Application Data
(63) Continuation of application No. PCT/EP05/05449, filed on May 19, 2005.

(30) Foreign Application Priority Data
Nov. 29, 2004 (DE) 10 2004 057 682.3

(51) Int. Cl. B23P 15/00

(52) U.S. Cl. 29/888.02

(57) ABSTRACT

Method for the production of a pressure-bearing part including a reducing piece, especially for housings of fittings, pumps, heat exchangers, distributors, and filters, including the steps of testing a blank for being defect-free, and producing the reducing piece from a blank. Blank is tested for flawlessness (defects) before reducing piece is produced from it. As blank itself has a simple geometry, the test of the blank for flawlessness can be performed in a simple manner. advantageously blank is a section of a pipe or a forging blank from which reducing piece is produced by way of turning, milling, or forging. Test of the blank for flawlessness can be performed by way of a method for nondestructive material testing, preferably by an ultrasonic volume test using a vertical probe.

### CROSS-REFERENCE TO RELATED APPLICATIONS

This application is a continuation of application No. PCT/EP2005/005449, filed May 19, 2005, which claims the priority of German application No. 10 2004 057 682.3, filed Nov. 29 2004, and each of which is incorporated herein by reference.

### FIELD OF THE INVENTION

The invention relates to a method for producing a pressure-bearing part including a reducing piece, especially for the housings of fittings, pumps, heat exchangers, distributors and filters.

### BACKGROUND OF THE INVENTION

These types of parts are used in different configurations and made out of different materials. Furthermore, the housings of fittings or filters are used, among other things, in vacuum, cryotechnics or cryogenics and high-temperature applications. To this end, housing parts used in the cryogenics field should have walls that are as uniform as possible, parts having vacuum insulation frequently being used in cryogenics. The vacuum insulation must guarantee that the vacuum can be generated and maintained, it therefore being necessary to use only pressure-bearing parts made of diffusion-resistant materials (forged, pressed material; clean).

High safety-related requirements must be placed on these pressure-bearing parts, depending on the application. If a control valve is used for a power plant, for example, the pressure-bearing housing of the fitting is subject to the TRD guidelines or CE Standard AD-2000. In order for the pressure-bearing parts to meet these requirements, nondestructive tests (e.g. using X-rays, ultrasound, or crack tests) must be performed at critical locations to guarantee that no material defects are present. Conducting the test is expensive and time-consuming because of the complex geometry of the parts.

### OBJECTS AND SUMMARY OF THE INVENTION

It is therefore an object of the invention to provide a method for the production of a pressure-bearing part including a reducing piece in which the test for flawlessness (i.e., being defect-free) is simplified.

The object of the invention is achieved by a method for the production of a pressure-bearing part including a reducing piece, especially for housings of fittings, pumps, heat exchangers, distributors and filters, encompassing the following steps:
testing a blank for being defect-free, and
producing the reducing piece from a particular blank.

To this end, the blank is tested for flawlessness (defects) before a reducing piece is produced from it. Since the blank itself has a simple geometry, the test of the blank for flawlessness can be performed in a simple manner.

To this end, it is advantageously provided that the blank is a section of a pipe or a forging blank from which the reducing piece is produced by way of turning, milling or forging.

The test of the blank for flawlessness (defects) can be performed by way of a method for nondestructive material testing, preferably by an ultrasonic volume test using a vertical probe.

In a preferred embodiment, it is provided that the reducing piece is provided with a bend, the bend preferably being a 90°-bend. But other bends can also be used. To this end, the bend is connected to the reducing piece at the location having the smaller diameter.

The connection between the reducing piece and the bend can be accomplished, for example, by way of a threaded connection or another suitable connecting device. But it is advantageously provided that the connection between the reducing piece and the bend is produced by welding.

This connection, which is produced by welding, between the reducing piece and the bend can be tested by way of a method for nondestructive material testing, preferably by ultrasonic volume testing using a vertical probe.

In another embodiment, it is provided that the bend and the reducing piece are connected to a T-piece, the T-piece being connected to the section of the reducing piece having the larger diameter, the bend fitting into the center of the T-piece.

This connection between the reducing piece and the bend can also be tested by way of a method for nondestructive material testing, preferably by ultrasonic volume testing using a vertical probe.

It is advantageously provided that the reducing piece, the bend or the T-piece is produced out of electroslag-remelted (ESR) material. This type of material is particularly pure steel that does not have lines of segregation and is particularly diffusion-resistant and therefore particularly suitable for use in the field of vacuum insulation.

To this end, it is advantageously provided that the material of the reducing piece or bend or T-piece is forged or pressed, so that a material with high diffusion-resistance is used in this manner.

In another preferred embodiment, it is provided that the pressure-bearing part produced in this way is provided with a cladding, so that the pressure-bearing part includes a double jacket, which can be monitored for leaks for example, so that a pressure-bearing part of this type including a cladding meets the highest safety requirements.

To this end, connection seams of the cladding, which arise by joining the cladding together and which were welded, can be tested by way of a method for nondestructive material testing, preferably by ultrasonic volume testing using a vertical probe.

It is preferably provided to this end that the nondestructive material testing is performed by way of ultrasonic volume testing. With this method, it is possible not only to detect and localize cracks on the surface but also to detect and localize material defects inside the material as well as to determine their size in a simple manner. Ultrasonic volume testing can be performed using different ultrasonic probes. But it is preferably provided that a vertical probe is used and placed onto the workpiece to be tested at a right angle. This type of vertical probe makes it possible to perform the ultrasonic volume test particularly easily and quickly.

Also forming a part of the invention is a pressure-bearing part including a reducing piece, especially for the housings of fittings, pumps, heat exchangers, distributors, and filters, this reducing piece being notable that it is produced according to the method according to the invention. Also forming a part of the invention is a reducing piece that is notable in that it is tested and produced according to the method according to the invention.

Relative terms such as left, right, up, and down are for convenience only and are not intended to be limiting.

### BRIEF DESCRIPTION OF THE DRAWINGS

FIG. 1 is a schematic view of a closed valve in accordance with the invention;

FIG. 2 is a schematic view of an open valve in accordance with the invention;

FIG. 3 is a schematic view of a blank in accordance with the invention;

FIG. 4 is a schematic view of a reducing piece in accordance with the invention;

FIG. 5 is a schematic view of a bend in accordance with the invention;

FIG. 6 is a schematic view of a bend connected to a reducing piece in accordance with the invention;

FIG. 7 is a schematic view of a T-piece in accordance with the invention;

FIG. 8 is a schematic view of a T-piece connected to the reducing piece and bend in accordance with the invention;

FIG. 9 is a schematic view of a T-piece, which is connected to the reducing piece and the bend, in a cladding in accordance with the invention; and

FIG. 10 is a schematic view of a second embodiment of a reducing piece with bend and T-piece with a cladding in accordance with the invention.

### DETAILED DESCRIPTION OF THE INVENTION

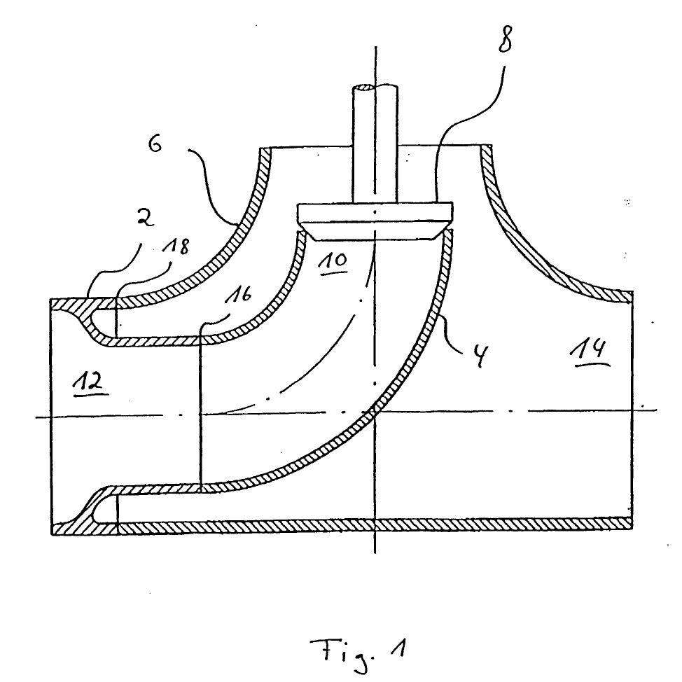

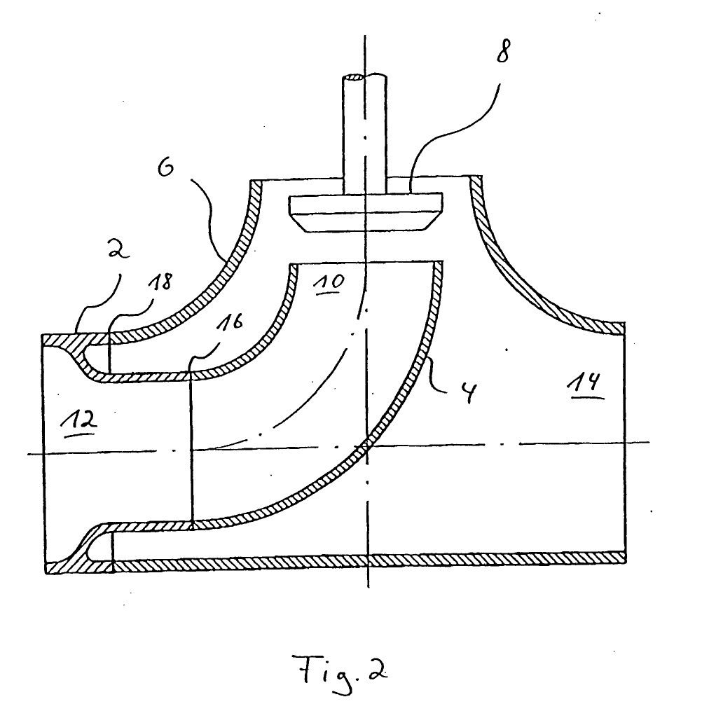

Reference is first made to FIGS. 1 and 2. Shown is a valve which includes an inlet 12 and an outlet 14, both of which can be connected to conduits. The inlet 12 and outlet 14 are connected together by a flow channel which can be opened and closed by a valve cone 8, the valve control unit for displacing the valve cone 8 between the open and closed positions being omitted for clarity.

The valve itself includes a reducing piece 2 of a cylindrical form or basic shape, to which a bend 4 is joined at connection point 16. The bend end 10 at the other end of the bend 4 can be opened or closed with the valve cone 8.

The reducing piece 2 furthermore forms the inlet 12. In addition, a T-piece 6 is joined to the reducing piece 2 at a connection point, e.g. joint, 18 in such a manner that the bend 4 joined to the reducing piece 2 is arranged in the interior of the T-piece 6.

When the valve cone 8 is opened, a material flow can thus flow along through the inlet 12 to the bend-end 10 of the bend 4 and then further through the interior of the T-piece 6 to the outlet 14.

To this end, the reducing piece 2, the bend 4 and the T-piece 6 are produced out of a high-purity steel, which does not include any segregation zones and is electroslag-remelted (ESR), for example, and the material is then forged or pressed.

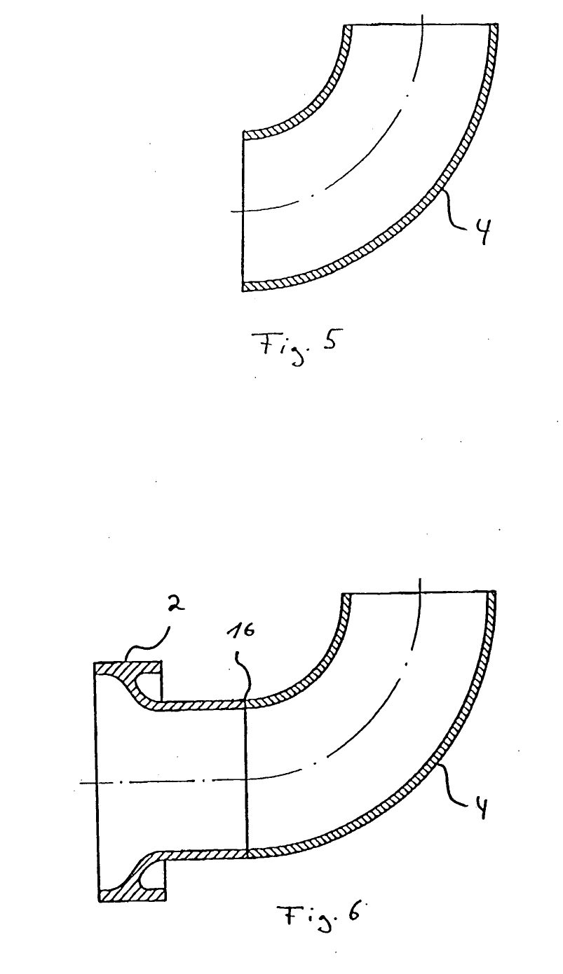

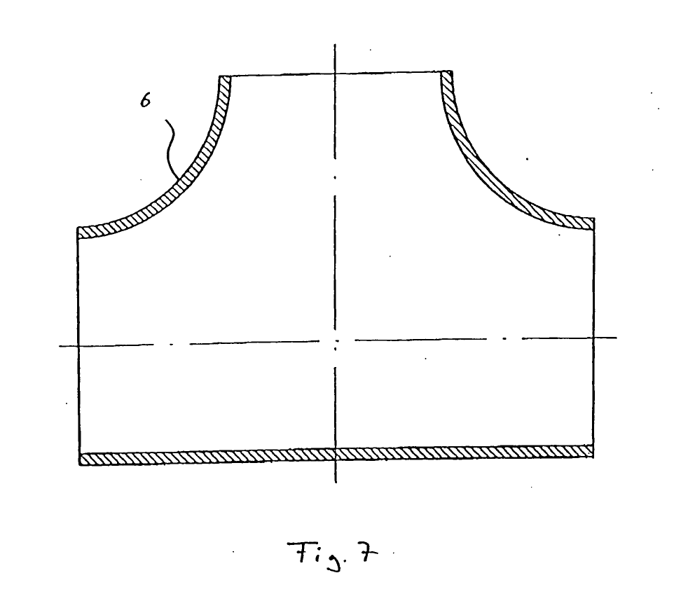

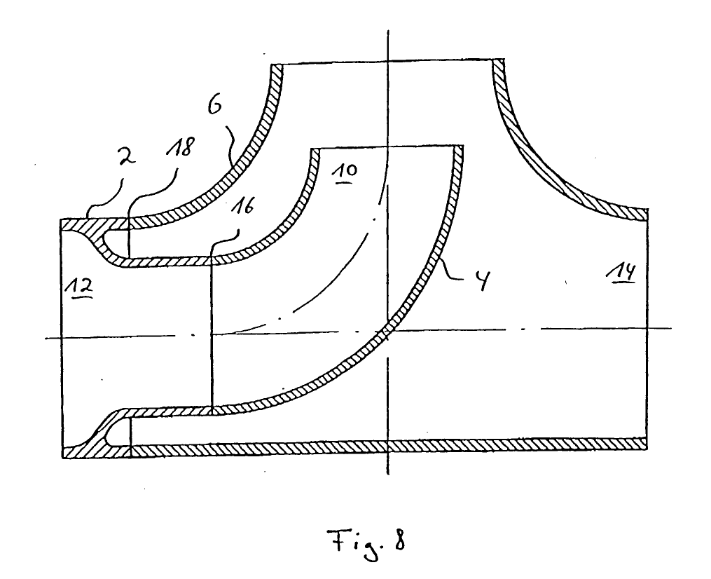

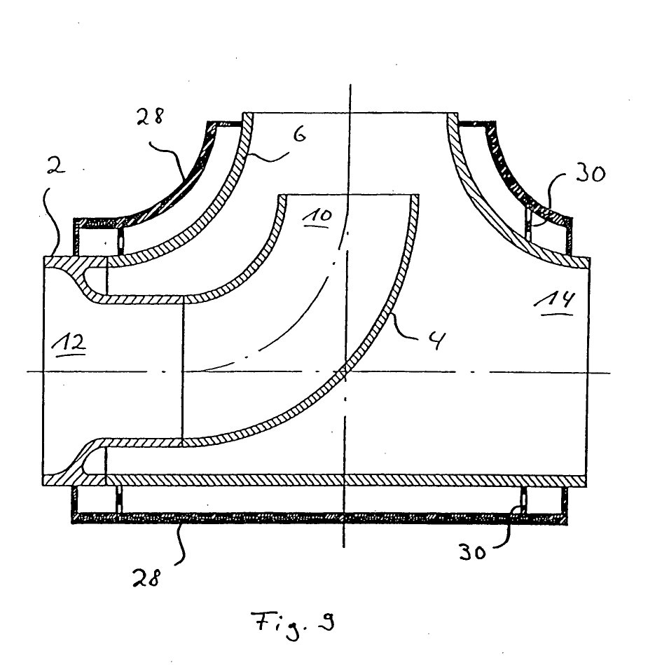

The production and testing of the valves depicted in FIGS. 1 and 2 will now be described in the following on the basis of FIGS. 3 to 8.

The reducing piece 2 is produced out of a blank 20, which can be a forging blank or a cross-cut section of a pipe, by turning, milling, forging, pressing, or precision casting. To this end, the blank 20 includes a cylindrical basic shape with a central passageway so that the blank 20 can be tested for flawlessness (defects) without problem, i.e., without difficulties, prior to further processing. To this end, the test of the blank for flawlessness (defects) can be performed by way of a method for nondestructive material testing, preferably by an ultrasonic volume test using a vertical probe.

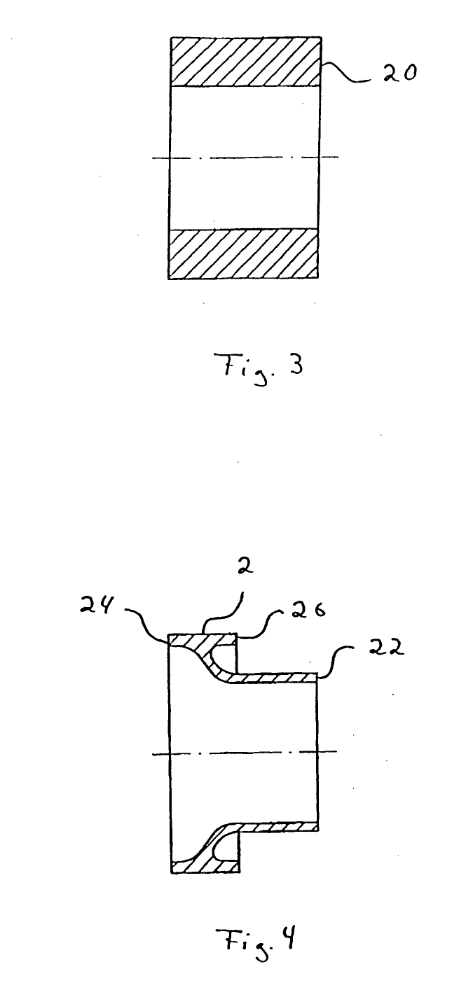

In a next step (see FIG. 4), the reducing piece 2 is produced from the blank 20 by turning, milling, forging, pressing, or precision casting. To this end, the reducing piece 2, in its final form, includes a first and a second connecting section 24, 26 having a large diameter, which are opposite one another, and a connecting section 22 having a small diameter. The first connecting section 24 having the large diameter will later form the inlet 12 of the valve and can be connected to a pipeline, while the second connecting section 26 having the large diameter serves for yielding a connection to a T-piece 6. The connecting section 22 having a small diameter serves for connecting the T-piece 2 to a bend 4. To this end, the connecting section 22 having the small diameter is configured as being elongated relative to the second connecting section 26 having the large diameter.

In that manner the connection point 16 between the connecting section 22 (having the smaller diameter) of the reducing piece 2 can be connected to the bend 4 by welding. This weld seam in the vicinity of the connection point 16 is easily accessible and can be tested by way of a method for nondestructive material testing, preferably by an ultrasonic volume test using a vertical probe.

In a next step, the bend 4, which is connected to the reducing piece 2, is inserted into the interior of the T-piece 6 in such a manner that it is arranged in the interior of the T-piece 6. At the connection point 18 between the reducing piece 2 and bend 4 to the T-piece 6, a connection between the two large diameters of the reducing piece 2 and the T-piece 6 is then produced by welding.

To this end, the connection point, e.g. joint, 18 between the reducing piece 2, the bend 4 and the T-piece 6 can be tested including a method for nondestructive material testing, preferably by an ultrasonic volume test using a vertical probe, because the connection point 18 to the reducing piece 2 with the bend 4 and T-piece 6 is easily accessible.

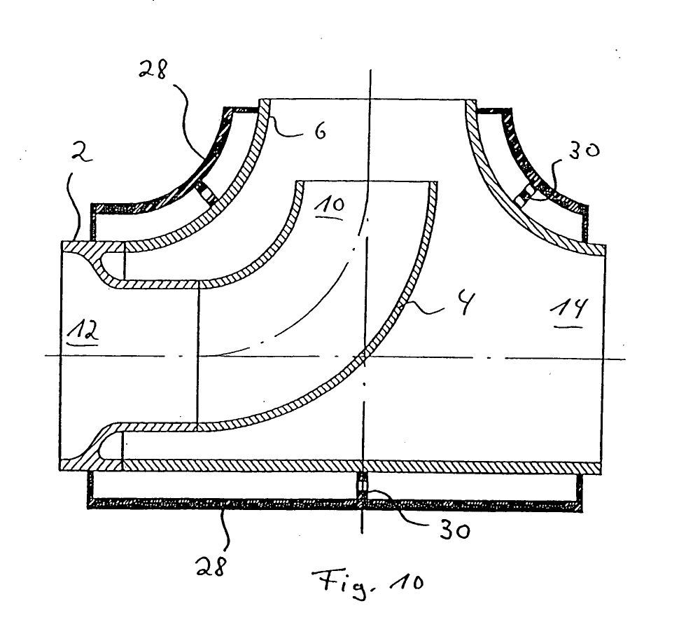

Reference is now made to FIGS. 9 and 10.

In another step, the valve is provided with a cladding 28 so that the valve is configured as a cladded double-walled valve, and the intermediate space between the valve and the double-walled cladding 28 can also be monitored for leaks, or space can be provided for a vacuum insulation. To this end, the cladding 28 includes two halves, which are joined to the valve and welded along connection seams. To this end, the cladding 28 includes a plurality of supports 30, which serve for fastening to and/or adjustment on the outside jacket of the valve.

The connection seams between the parts of the cladding 28 can be tested by way of a method for nondestructive material testing, preferably by an ultrasonic volume test using a vertical probe, so that it is guaranteed that the weld seams of the cladding 28 are also flawless. To facilitate the testing of the weld seams, the supports 30 are arranged relative to the weld seams in such a manner that that the weld seams stand back from and are not arranged in the vicinity of the supports 30.

The valve cone 8 is then mounted together with the valve control unit so that a double-walled valve for the highest safety requirements is available.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Method for the production of a pressure-bearing part including a reducing piece, comprising the following steps:
a) testing a blank for flawlessness; and
b) producing the reducing piece from the tested blank, the reducing piece being configured as a housing for one of fittings, pumps, heat exchangers, distributors, and filters encompassing.

2. Method according to claim 1, wherein:
a) the blank is a section of one of a pipe and a forging blank.

3. Method according to claim 1, wherein:
a) the reducing piece is produced from the blank by one of turning, milling, forging, pressing, and precision casting.

4. Method according to claim 1, wherein:
a) the testing includes a method for nondestructive material testing.

5. Method according to claim 1, wherein:
a) the reducing piece is connected to a bend.

6. Method according to claim 5, wherein:
a) a weld connection is produced at a connection point between the reducing piece and the bend.

7. Method according to claim 6, wherein:
a) the connection point is tested by way of a method for nondestructive material testing.

8. Method according to claim 5, wherein:
a) the reducing piece is connected to a T-piece.

9. Method according to claim 8, wherein:
a) a weld connection is produced at a connection point between the reducing piece and the T-piece.

10. Method according to claim 9, wherein:
a) the connection point is tested by way of a method for nondestructive material testing.

11. Method according to claim 8, wherein:
a) one of the reducing piece, the bend, and the T-piece is produced out of electroslag-remelted (ESR) material.

12. Method according to claim 8, wherein:
a) the material of one of the reducing piece, the bend, and the T-piece is one of forged and pressed.

13. Method according to claim 8, wherein:
a) the pressure-bearing part includes a cladding.

14. Method according claim 13, wherein:
a) the cladding includes connection seams, and the connection seams of the cladding are tested by way of a method for nondestructive material testing.

15. Method according to claim 1, wherein:
a) the pressure-bearing part includes a cladding.

16. Method according to claim 4, wherein:
a) an ultrasonic volume test is performed.

17. Method according to claim 16, wherein:
a) a vertical probe is used for the ultrasonic volume test.

18. Pressure-bearing part including a reducing piece produced according to the method of claim 16.

19. Pressure-bearing part including a reducing piece produced according to the method of claim 1.
